(19) United States
(12) Patent Application Publication
(10) Pub. No.: US 2014/0004482 A1
(43) Pub. Date: Jan. 2, 2014

(54) METHODS, COMPOSITIONS AND APPARATUS FOR APPLYING AN AGENT TO A DENTAL SUBSTRATE AND USES THEREOF

(71) Applicants: CHRISTOS ANGELETAKIS, Orange, CA (US); Gregory J. Dorsman, Anaheim, CA (US)

(72) Inventors: CHRISTOS ANGELETAKIS, Orange, CA (US); Gregory J. Dorsman, Anaheim, CA (US)

(21) Appl. No.: 13/929,276

(22) Filed: Jun. 27, 2013

Related U.S. Application Data
(60) Provisional application No. 61/666,591, filed on Jun. 29, 2012.

(51) Int. Cl. A61C 19/06

(52) U.S. Cl. CPC A61C 19/063
USPC 433/217.1

(57) ABSTRACT

A dental agent that is applied to a dental substrate is disclosed and includes: at least one breakable capsule, microcapsule or combination thereof, wherein the at least one breakable capsule, microcapsule or combination thereof comprises at least one adhesive primer, or a combination thereof. Methods of applying contemplated dental agents are also disclosed that include: providing a dental agent, wherein the dental agent comprises at least one breakable capsule, microcapsule or a combination thereof, providing a dental substrate, applying the dental agent to the dental substrate, and breaking the at least one breakable capsule, microcapsule or combination thereof on the surface of the dental substrate.

This U.S. Utility application claims priority to U.S. Provisional Application Ser. No. 61/666591 filed on Jun. 29, 2012 and entitled “Method, Composition, and Apparatus for Applying Agent to Dental Substrate”, which is commonly-owned and incorporated herein in its entirety by reference.

### FIELD OF THE SUBJECT MATTER

The field of the subject matter is agents and materials that are applied to dental substrates, including the compositions, methods and uses thereof.

### BACKGROUND

Dentistry practices require the use of adhesives being applied to dental substrates. In the past, the blasting of particulate matter, such as alumina, has often been used to roughen the surface of a dental substrate, such as a metal, composite or a ceramic, such as porcelain, zirconia, alumina, lithium disilicate, and the like. The alumina blasting is usually followed by the application of a primer, which in the case of metal or composite or silicate based ceramics is usually a silane primer. However, in the case of a zirconia-based ceramics an acid containing primer is used, such as Clearfil™ ceramic primer by Kuraray Inc. These ceramic primers contain an acid methacrylate such as methacryloyloxydecyl dihydrogen phosphate (MDP). The use of the primer is followed by applying a luting cement prior to placement of the prosthesis or by a composite resin for repair.

Tribochemical silica can also be used as the sandblasting medium instead of alumina. Tribochemical silica is a ceramic sand that is composed mainly of alumina particles with silica on the surface of these particles. For example, a product known as SiIJet™, (Danville Materials Inc., San Ramon, Calif.) utilizes tribochemical silica. A ceramic coating mostly composed of silica forms upon blasting the surface of the substrate with tribochemical silica. Blasting causes this ceramic coating to be firmly anchored to the surface through a chemical interaction with the surface, which in this case is considered a “tribochemical” interaction or reaction.

Tribochemistry relates to chemical changes occurring to two interacting surfaces, in this case caused by friction and impact. The blasting is followed by the application of a silane primer on the substrate using a brush. This silane layer is necessary to assure good bonding between the acrylate functional resin based composite material and the blasted surface. This process can be compared to simply blasting with alumina, a much lower priced blasting medium, followed by application of a ceramic primer such as Clearfil™ ceramic primer by Kuraray Inc or a special primer developed for zirconia-based ceramics, ZBond™, (Danville Materials, Inc., San Ramon, Calif.). In any case, the use of tribochemical silica or alumina followed by the application of primers represents a two-step process.

Sandblasting is commonly used for the cleaning of implants or other dental surfaces from discoloration and debris. Relatively non-abrasive polishing powders such as sodium bicarbonate or sodium-free calcium carbonate are commonly used for cleaning to remove plaque and biofilm or prophylaxis. However, more abrasive powders, such as aluminum oxide and glass beads or the tribochemical silica mentioned above, can also be used for cleaning. Subsequent to this cleaning step, antibacterial or enamel strengthening solutions are applied as a separate step.

To this end, it would be desirable to develop, produce and utilize a dental agent that can be applied to a dental substrate that uses a blasting technique that is easier to use and more contained, that may be utilized intraorally, and that utilizes conventional abrading equipment.

### SUMMARY OF THE SUBJECT MATTER

A dental agent that is applied to a dental substrate is disclosed and includes: at least one breakable capsule, microcapsule or combination thereof, wherein the at least one breakable capsule, microcapsule or combination thereof comprises at least one adhesive primer, at least one active ingredient or a combination thereof.

A dental agent that is propelled onto a dental substrate is disclosed, wherein the dental agent comprises: at least one breakable capsule, microcapsule or combination thereof, wherein the at least one breakable capsule, microcapsule or combination thereof comprises at least one adhesive primer, at least one active ingredient, or a combination thereof.

Methods of applying contemplated dental agents are also disclosed that include: providing a dental agent, wherein the dental agent comprises at least one breakable capsule, microcapsule or a combination thereof, providing a dental substrate, applying the dental agent to the dental substrate, and breaking the at least one breakable capsule, microcapsule or combination thereof on the surface of the dental substrate.

### BRIEF DESCRIPTION OF THE FIGURES

FIG. 1 is a flow diagram illustrating a contemplated method.

FIG. 2 is a side elevational schematic view of a possible structure of a contemplated microcapsule used in contemplated methods and apparatus.

FIG. 3 is a sectional view taken along line 3-3 of FIG. 2.

FIG. 4 is a schematic view illustrating the blasting of the mixture material of a contemplated embodiment on a dental substrate.

### DETAILED DESCRIPTION

A dental agent has been developed and is utilized that can be applied to a dental substrate, wherein the agents allow the use of a blasting technique that is easier to use and more contained, wherein the complete process may be utilized intraorally, and wherein the process utilizes conventional abrading equipment. It has been found that the bond strength between the dental substrate and such dental restoratives, using the one-step method of the present invention, equals or exceeds the bond strength achieved in prior art two-step method.

Specifically, dental agents, as disclosed herein, that are applied to a dental substrate comprise at least one breakable capsule, microcapsule or combination thereof, wherein the at least one breakable capsule, microcapsule or combination thereof comprises at least one adhesive primer, at least one active ingredient or a combination thereof. In some embodiments, these dental agents may be combined with at least one abrasive material. In some embodiments, a dental agent that is propelled onto a dental substrate is disclosed, wherein the dental agent comprises: at least one breakable capsule, microcapsule or combination thereof, wherein the at least one breakable capsule, microcapsule or combination thereof comprises at least one adhesive primer, at least one other agent, at least one active ingredient, or a combination thereof.

Methods of applying dental agents comprise: providing a dental agent, wherein the dental agent comprises at least one breakable microcapsule, providing a dental substrate, applying the dental agent to the dental substrate, breaking the at least one breakable microcapsules on the surface of the dental substrate. Contemplated methods also include utilizing conventional abrading equipment to effectively initiate the intentioned use of the at least one breakable microcapsules. In some embodiments, applying the at least one capsule, microcapsule or combination thereof comprising blasting, propelling, shooting, brushing or a combination thereof. In other embodiments, blasting, propelling, shooting or a combination thereof comprises applying with enough kinetic energy to break the breakable capsule, microcapsule or combination thereof.

In one embodiment, microcapsules comprise a core material encapsulated within a shell, wherein the core material comprises at least one active ingredient, and the microcapsule shell comprises at least one inorganic polymer, such as silica at a thickness that will assure effective breakage of the microcapsules upon blasting. In some embodiments, the microcapsules may also be filled with therapeutic agents, such as antimicrobial agents or tooth-strengthening substances, in order to provide additional dental treatments.

In another contemplated embodiment, a method for using a blasting medium containing these microcapsules is utilized. Specifically, these microcapsules may be mixed with abrasive particles for application to dental substrates. The mixture of the particulate abrasive particles and the microcapsules is blasted to cause impingement on a dental substrate forcing the microcapsules to break on impact. Thus, the abrasive particles treat the dental substrate surface, while the broken microcapsules deliver the silane primer, resulting in a surface which is ready for immediate application of resin based restoratives, such as composites.

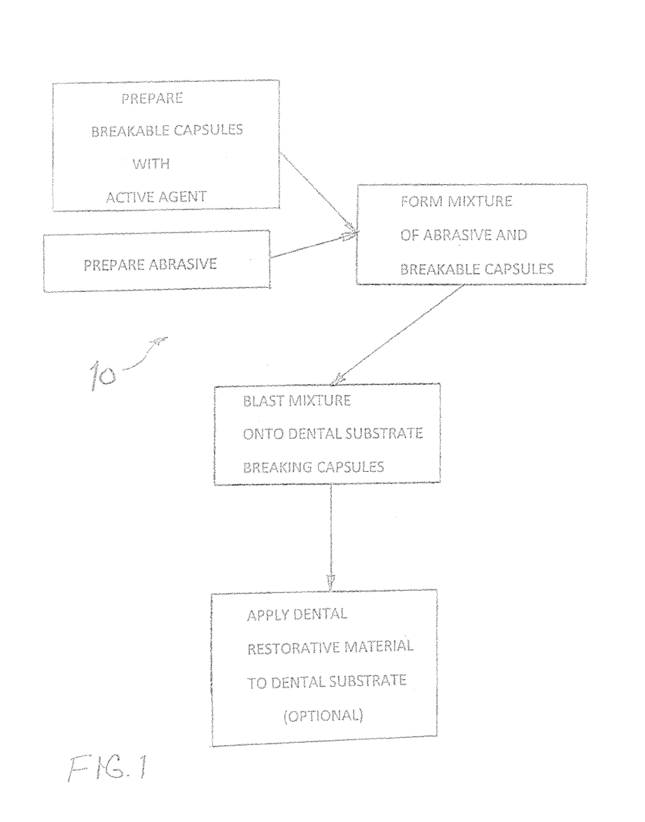

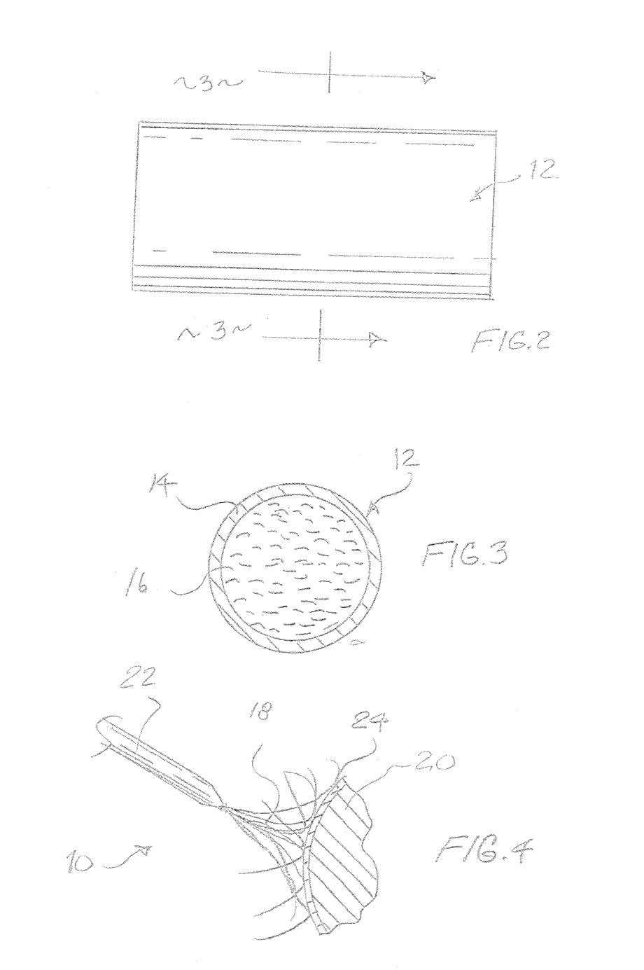

FIG. 1 shows a contemplated method or procedure 10 that includes the preparation of a breakable capsule or microcapsule 12 that is depicted schematically in FIG. 2 as being generally spheroidal in shape. In some embodiments, a contemplated microcapsule 12 may take other forms known in the art such as cylindrical, ellipsoidal, non-spheroidal and the like.

A microcapsule 12 may stay separated from other microcapsules or may agglomerate with other microcapsules, each having a specific or an arbitrary shape. As depicted in FIG. 2, a contemplated microcapsule 12 will rupture or break upon impact on a surface, which will be discussed hereinafter.

A contemplated microcapsule 12 may be formed with a shell 14 having a wall of a predetermined thickness to insure breakage upon impact on a dental surface. In addition, shell 14 may possess a non-uniform thickness. For example, a microcapsule may possess an average wall thickness of approximately 30 microns; however, any suitable thickness is contemplated depending on the process and materials. In some embodiments, an average wall thickness may be more than 30 microns, and in other embodiments, the average wall thickness may be less than 30 microns. Moreover, shell 14 may be composed of multiple chemical components. For example, shell 14 may be fashioned from at least one inorganic polymer such as silica.

At least one active agent or ingredient 16 is located within microcapsule 12 and may take the form of an adhesive agent or ceramic primer, such as silanes, including methacryl functional silane that can be utilized to prepare metal or certain ceramic surfaces for bonding, or a methacryl functional organophosphate, such as methacryloxy decyl phosphate or MDP, and the like, which is generally used for the preparation of dental substrates composed of zirconia based ceramics for bonding. Of course other primers may be utilized as agent 16, commensurate with a particular dental substrate material.

In some contemplated embodiments, agent or ingredient 16 may take the form of a therapeutic agent, such as chlorhexidine, organic amine fluorides such as cetylamine fluoride, and the like. Also, agent or ingredient 16 may comprise calcium based silicates and the like or other compound types. In general, agent or ingredient 16 may include single or multiple chemical entities in single microcapsules or in multiple capsules.

Contemplated microcapsules 12 may be prepared by various methods known in the art of encapsulation. For example, active agent or ingredient 16 may enter shell 14 by pushing or forcing active agent or active ingredient 16 through the pores of shell 14 and expelling air within shell 14 at the same time. Another method of preparation of microcapsule 14 is to hydrolyze the same in an oil-in-water emulsion which contains hydrolyzable organic polymer precursors such as tetraethyl orthosilicates (TEOS), as disclosed in U.S. Pat. No. 8,110,284.

Further, a blasting medium of abrasive materials is also provided. Such abrasive medium may include alumina, or tribochemical silica. Such tribochemical silica may be prepared by a sol gel method where a silica layer is precipitated, via the hydrolysis of tetraethyl orthosilicates (TEOS), onto alumina particles in a stirred solution. In any case, a silica composition known as SilJet™ may be used, available from Danville Materials Inc., in San Ramon Calif.

With reference to FIG. 1, it may be seen that a mixture of the breakable microcapsules 12 containing agent or ingredient 16 and the abrasive medium are formed into a mixture or blasting medium 18, FIG. 4. In certain cases mixture or blasting medium 18 may contain an abrasive medium with a predetermined amount of microcapsules 12 containing one or more agents or ingredients 16. Such mixture 18 is blasted or shot onto a dental substrate 20, such as porcelain, zirconia, alumina, lithium disilicate, composite, metal and the like.

As described herein and in a contemplated embodiment, a blasting medium containing tribochemical silica and microcapsules loaded with silane is uilized for the enhancement of the adhesion of metals and ceramics to resins and cements. The same bond strength is achieved compared to when tribochemical silica is used alone with the use of a silane primer as a separate step. Yet another contemplated embodiment includes the use of a blasting medium containing tribochemical silica and microcapsules loaded with silane and microcapsules loaded with a methacrylate functional organophosphate for the enhancement of the adhesion of zirconia based ceramics to resins and cements. In addition, another contemplated embodiment includes using a blasting medium containing tribochemical silica and microcapsules loaded with chlorhexidine for disinfection of tooth surfaces.

It should also be seen from FIG. 4, that mixture 18 is air abraded using an etcher or blaster, such as the Microetcher II™ sold by Danville Materials, Inc of San Ramon Calif. It should also further be realized that when mixture 18 is blasted onto the surface of dental substrate 20, microcapsules, such as microcapsule 12, break upon impact and deliver active agent 16 to substrate 20. Thus, dental substrate 20 is prepared for bonding of dental restorative entities, such as resin based composites, and the like. As mentioned earlier, it has been found that the bond strength between the dental substrate and such dental restoratives, using the one step method of the current disclosure, equals or exceeds the bond strength achieved in prior art two-step method.

### EXAMPLES

### Analytical Test Methods

### Shear Bond Strength Test

Typical dental substrate material samples having adhesion surfaces of interest were embedded in a two-part room temperature curing epoxy. Following application of the epoxy, each sample was sanded with 320 and 600 grit wet sandpaper using a rotary sander (Metasery 250, Buehler of Lake Bluff, Ill.). Eight samples were used for each test. As mentioned, each sample was sanded with 320 and 600 grit wet sandpaper using a rotary sander (Metasery 250, Buehler of Lake Bluff, Ill.). The samples were then air abraded (Microetcher II, Danville Materials Inc., San Ramon, Calif.) using the abrasion medium disclosed herein and in the Examples for 10 seconds, at a 90 degree angle from approximately 1 cm distance above the sample. Excess powder residue was blown away using an air syringe. For the optional application of primer, the following options can be utilized: a) silane primer (S-bond™, Danville Materials Inc., San Ramon, Calif.): after brushing surface is allowed to stand for 30 seconds, and then air dried for 10 seconds; and b) zirconia Primer (Z-bond™, Danville Materials Inc., San Ramon, Calif.): after brushing surface is allowed to stand for 30 seconds, and then air dried for 5 seconds. The samples were then mounted onto an Ultradent™ jig (Ultradent Inc., South Jordan Utah) and fitted with mold insert to bonding site. A mold insert, having 2.3 square millimeters of bond area, was filled with a dual cured flowable composite (StarFil 2B™, Danville Materials Inc., San Ramon, Calif.). The molded composite was then allowed to cure in a humidor at ca. 35 degrees centigrade for 10 minutes. The samples were removed from the jig and stored in water at 37 degrees centigrade for two days. Following such storage, the samples were placed in boiling water for 4 hours and then replaced in 37 degree water in an oven for 1 day. The shear bond strength was then determined on an Instron™ universal testing machine (Canton, Mass.) at a crosshead speed of 1.0 mm/min.

### Loss on Ignition Test

The microcapsules were heated in a programmable furnace for 30 min at 200 C. followed by 1 hour at 600 C. and then placed in a desiccator to cool to room temperature. The percent weight loss was recorded.

Materials used in the Examples:

MPTMS silane: gamma-methacryloxypropyltrimethoxysilane.

MDP: Methacryloyloxydecyl dihydrogen phosphate.

Lava: Lava™ Frame Framework Ceramic (3M ESPE, St. Paul, Minn.). Ceramic material for the frame component for crowns and bridges.

### Example 1

### Microcapsules Containing MPTMS

The microcapsules used were obtained from Sukgyung (Korea) and were prepared using silica elongated spheres having a wall thickness of approximately 30 μm. These microcapsules were filled with MPTMS silane through the pores. The microcapsules were then sealed by the reaction of MPTMS near the pores with water vapor from ambient air. The “loss on ignition” test on these microcapsules showed a 64% weight loss.

### Example 2

### Microcapsules Containing MDP

Microcapsules are prepared using silica elongated spheres having a wall thickness of approximately 30 μm. These microcapsules are then partially filled with methacryloyloxydecyl dihydrogen phosphate (MDP) through the pores. These microcapsules are then completely filled with MPTMS silane through the pores. The microcapsules are then sealed by the reaction of MPTMS near the pores with water vapor from ambient air.

### Example 3

### Microcapsules Containing Chlorhexidine

Microcapsules are prepared using silica elongated spheres having a wall thickness of approximately 30 μm. These microcapsules are then partially filled with chlorhexidine through the pores. Such microcapsules are then completely filled with MPTMS silane through the pores. The microcapsules are then sealed by the reaction of MPTMS near the pores with water vapor from ambient air.

### Example 4

### Preparation of Blending to Form Mixtures of Abrasives and Microcapsules

Tribochemical silica (SilJet, Danville Materials Inc., San Ramon, Calif.) containing 7% silica with alumina at a 9 to 1 weight ratio of silica to alumina was placed in a straight wall jar together with microcapsules containing active agents at different weight ratios varying from 0-5%. The mixtures were then tumbled on a 2 roll mill. After tumbling, the mixture was screened through a 75 um stainless steel sieve and stored in a desiccator.

### Example 5

### Use of Example 4 Mixtures on Metal Dental Substrate

Tribochemical silica containing microcapsules with MPTMS silane was blasted at 45 psi on non-precious metal (Rexyllium V). A commercial silane primer (S-Bond, Danville Calif.) was applied as control on one set of samples as it is the standard step for using SilJet according to the instructions of use. Table 1 shows the shear bond strengths obtained using varying weight percentages of micro capsules in the blasting powder mixture.

TABLE 1

| Weight % | | | |
|---|---|---|---|
| Micro-capsules in | Silane Primer | Mean Shear Bond | |
| Blasting Power | Applied | Strength, Mpa | Std. Dev. |
| 1 | No | 24.2 | 5.2 |
| 0.75 | No | 18.6 | 2.2 |
| 0.5 | No | 20.0 | 5.9 |
| 0.25 | No | 17.8 | 3.9 |
| 0 | Yes | 20.9 | 3.3 |
| 0 | No | 7.5 | 5.2 |

Silane Primer used was S-Bond™,(Danville Materials Inc, San Ramon, Calif.)

### Example 6

### Use of Example 4 Mixtures on Ceramic Dental Substrate

Tribochemical silica containing microcapsules with MPTMS silane was blasted at 45 psi on on Lava Zirconia sold by 3M Company of St. Paul Minn. A commercial silane primer (S-Bond™, Danville Calif.) was applied as a control on one set of samples, as it is the standard step for using SiIJet™ according to the instructions of use. A zirconia primer was also utilized in this Example. Table 2 shows the shear bond strength values.

TABLE 2

| Weight % | | Mean (Mpa) | |
|---|---|---|---|
| Micro-capsules in | | Shear Bond | |
| Blasting Power | Primer Applied | Strength | Std. Dev. |
| 2.5 | No | 13.5 | 1.5 |
| 1 | No | 8.3 | 21. |
| 0 | S-Bond | 14.1 | 3.2 |
| 0 | No | 1.4 | 0.4 |
| A | Z-Bond | 13.0 | 1.8 |
| 0 | Z-Bond | 5.5 | 0.9 |

Silane Primer used was S-Bond™, (Danville Materials Inc, San Ramon, Calif.); Zirconia Primer used was ZBond™, (Danville Materials, Inc San Ramon, Calif.); A-Alumina Blasting medium used instead of tribochemical silica.

The results of Examples 5 and 6, with respect to ceramic (zirconia) and metal

(Rexyllium V) dental substrates, show that the combination of abrasive medium and agent filled microcapsules exhibit shear bond strength values, equivalent to, or better than, the prior art two-step blasting and primer application. It should also be noted that an equivalent result was obtained when alumina (A) was used in Example 5 as a blasting abrasive together with a zirconia primer, such as Z-Bond™, in a prior art two-step method.

Thus, specific embodiments and methods of the agents that are applied to dental substrates have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A dental agent that is applied to a dental substrate, comprising:
at least one breakable capsule, microcapsule or combination thereof, wherein the at least one breakable capsule, microcapsule or combination thereof comprises at least one adhesive primer, at least one active ingredient, or a combination thereof.

2. The dental agent of claim 1, further comprising at least one abrasive material.

3. The dental agent of claim 1, wherein the capsule, microcapsule or combination thereof is agglomerated.

4. The dental agent of claim 1, wherein the capsule, microcapsule or combination thereof is non-agglomerated.

5. The dental agent of claim 1, wherein the capsule, microcapsule or combination thereof comprises a specific shape.

6. The dental agent of claim 1, wherein applying the dental agent comprises blasting, propelling, shooting, brushing or a combination thereof.

7. The dental agent of claim 1, wherein the capsule, microcapsule or combination thereof comprises gamma-methacryloxypropyltrimethoxy silane, methacryloyloxydecyl dihydrogen phosphate, chlorhexidine or a combination thereof.

8. The dental agent of claim 1, wherein the capsule, microcapsule or combination thereof comprises a wall thickness of less than about 30 μm.

9. The dental agent of claim 1, wherein the capsule, microcapsule or combination thereof comprises a wall thickness of greater than about 30 μm.

10. The dental agent of claim 2, wherein the at least one abrasive material comprises silica.

11. The dental agent of claim 2, wherein the at least one abrasive material comprises tribochemical silica.

12. The dental agent of claim 1, wherein the dental substrate comprises a metal dental substrate, a ceramic dental substrate or a combination thereof.

13. The dental agent of claim 1, further comprising at least one therapeutic material.

14. A method of applying contemplated dental agents comprising:
providing a dental agent, wherein the dental agent comprises at least one breakable capsule, microcapsule or a combination thereof, providing a dental substrate,
applying the dental agent to the dental substrate, and
breaking the at least one breakable capsule, microcapsule or combination thereof on the surface of the dental substrate.

15. The method of claim 14, wherein applying the at least one capsule, microcapsule or combination thereof comprising blasting, propelling, shooting, brushing or a combination thereof.

16. The method of claim 15, wherein blasting, propelling, shooting or a combination thereof comprises applying with enough kinetic energy to break the breakable capsule, microcapsule or combination thereof.

17. The method of claim 14, wherein breaking the at least one capsule, microcapsule or combination thereof comprises air-blasting the dental substrate.

18. The method of claim 14, further comprising utilizing abrading equipment to effectively initiate the intentioned use of the at least one breakable capsule, microcapsule or combination thereof.

19. The method of claim 14, wherein the capsule, microcapsule or combination thereof is sealed with water vapor and heat cured.

20. The method of claim 14, wherein the at least one breakable capsule, microcapsule or combination thereof comprises at least one adhesive primer, at least one other agent, at least one active ingredient, or a combination thereof.

21. A dental agent that is propelled onto a dental substrate, wherein the dental agent comprises: at least one breakable capsule, microcapsule or combination thereof, wherein the at least one breakable capsule, microcapsule or combination thereof comprises at least one adhesive primer, at least one active ingredient, or a combination thereof.
